(19) United States
(12) Patent Application Publication
(10) Pub. No.: US 2020/0240187 A1
(43) Pub. Date: Jul. 30, 2020

(54) SPRING-BIASED GARAGE DOOR ROLLER

(71) Applicant: PAUL WISE, JR., Hickory, NC (US)

(72) Inventor: PAUL WISE, JR., Hickory, NC (US)

(21) Appl. No.: 16/260,265

(22) Filed: Jan. 29, 2019

(51) Int. Cl. E05D 15/16

(52) U.S. Cl. CPC E05D 15/165; E05F 1/16; E05Y 2900/106

(57) ABSTRACT

The spring-biased garage door roller is configured for use with a garage door. The garage door comprises the garage door, a plurality of tracks, a plurality of roller wheels, and a plurality of compression springs. The plurality of roller wheels and the plurality of compression springs combine to attach the garage door to the plurality of tracks. The plurality of tracks guide the motion of the plurality of roller wheels. There is a one to one correspondence between the plurality of roller wheels and the plurality of compression springs. Each individual compression spring generates a motive force that urges its associated individual roller wheel into a track selected from the plurality of tracks.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of building including door fittings, more specifically, a hinged suspension device moveable in a perpendicular direction that rotates around an axis. (E05D2700/12)

### SUMMARY OF INVENTION

The spring-biased garage door roller is configured for use with a garage door. The garage door comprises a plurality of door panels and a plurality of hinges. The plurality of hinges interconnect the plurality of door panels such that the relative position of any second door panel selected from the plurality of door panels will rotate relative to any first door panel selected from the plurality of door panels as the garage door moves between the closed position and the open position. The spring-biased garage door roller comprises the garage door, a plurality of tracks, a plurality of roller wheels, and a plurality of compression springs. The plurality of roller wheels and the plurality of compression springs combine to attach the garage door to the plurality of tracks. The plurality of tracks guide the motion of the plurality of roller wheels. There is a one to one correspondence between the plurality of roller wheels and the plurality of compression springs. Each individual compression spring generates a motive force that urges its associated individual roller wheel into a track selected from the plurality of tracks.

These together with additional objects, features and advantages of the spring-biased garage door roller will be readily apparent to those of ordinary skill in the art upon reading the following detailed description of the presently preferred, but nonetheless illustrative, embodiments when taken in conjunction with the accompanying drawings.

In this respect, before explaining the current embodiments of the spring-biased garage door roller in detail, it is to be understood that the spring-biased garage door roller is not limited in its applications to the details of construction and arrangements of the components set forth in the following description or illustration. Those skilled in the art will appreciate that the concept of this disclosure may be readily utilized as a basis for the design of other structures, methods and systems for carrying out the several purposes of the spring-biased garage door roller.

It is therefore important that the claims be regarded as including such equivalent construction insofar as they do not depart from the spirit and scope of the spring-biased garage door roller. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a side view of an embodiment of the disclosure.

FIG. 3 is a front view of an embodiment of the disclosure.

FIG. 4 is an exploded view of an embodiment of the disclosure.

FIG. 5 is an in-use view of an embodiment of the disclosure.

FIG. 6 is a detail view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

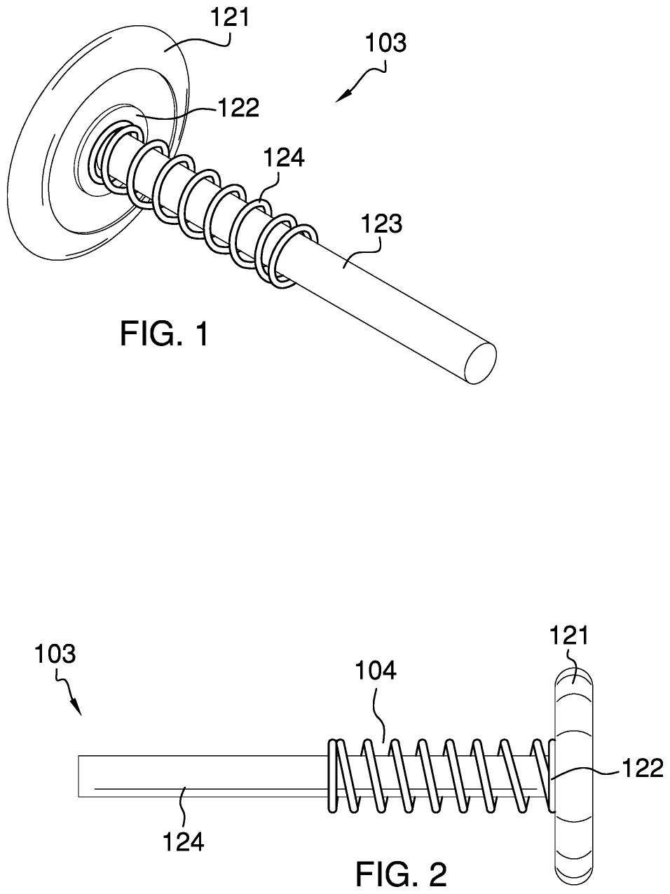

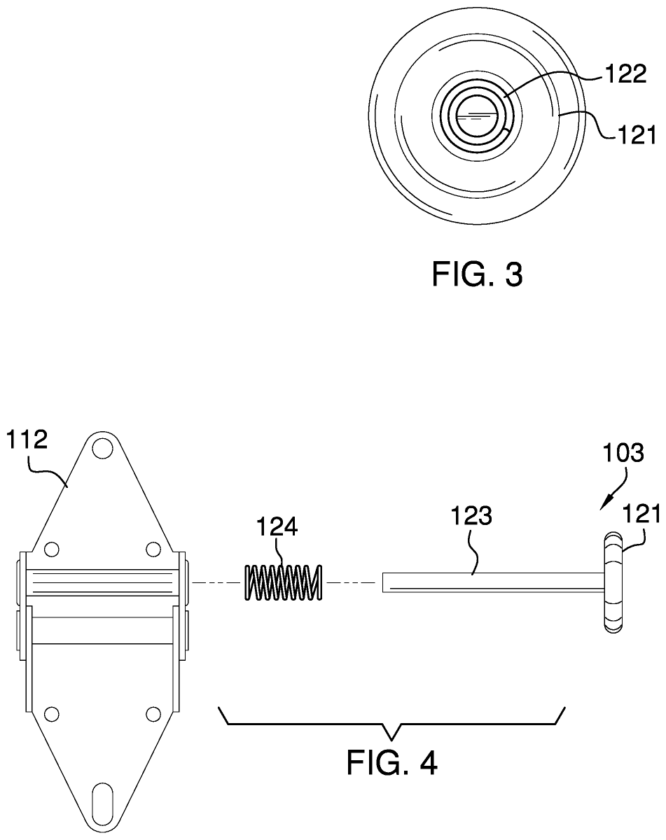

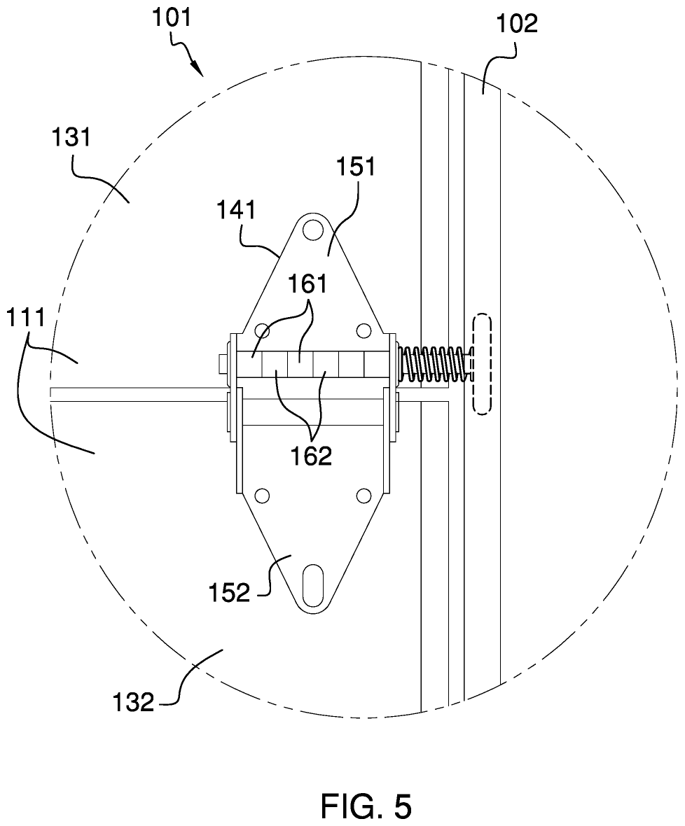

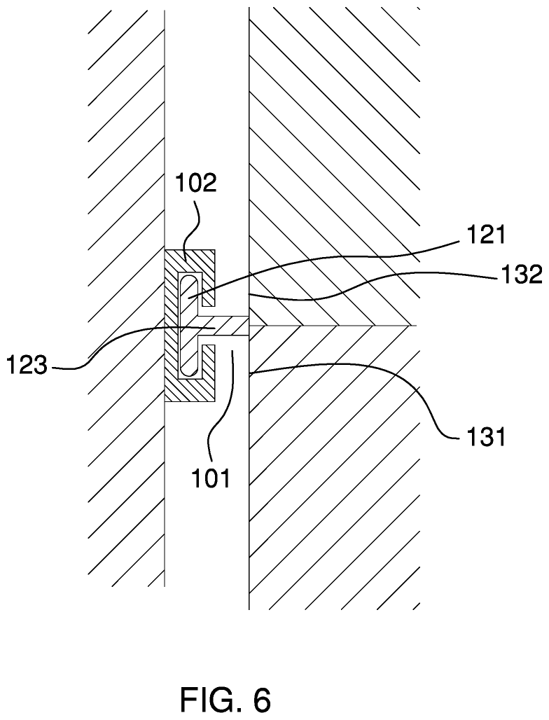

Detailed reference will now be made to one or more potential embodiments of the disclosure, which are illustrated in FIGS. 1 through 6.

The spring-biased garage door roller 100 (hereinafter invention) is configured for use with a garage door 101. The garage door comprises a plurality of door panels 111 and a plurality of hinges 112. The plurality of hinges 112 interconnect the plurality of door panels 111 such that the relative position of any second door panel 132 selected from the plurality of door panels 111 will rotate relative to any first door panel 131 selected from the plurality of door panels 111 as the garage door 101 moves between the closed position and the open position.

The invention 100 comprises the garage door 101, a plurality of tracks 102, a plurality of roller wheels 103, and a plurality of compression springs 104. The plurality of roller wheels 103 and the plurality of compression springs 104 combine to attach the garage door 101 to the plurality of tracks 102. The plurality of tracks 102 guide the motion of the plurality of roller wheels 103. There is a one to one correspondence between the plurality of roller wheels 103 and the plurality of compression springs 104. Each individual compression spring 124 generates a motive force that urges its associated individual rotating wheel 121 into a track selected from the plurality of tracks 102.

The garage door 101 is a door that is commonly used to control access to a garage. The garage door 101 is sized such that a vehicle can be driven into and out of the garage. The garage door 101 is a multi-component rotating structure such that the garage door 101 will bend ninety degrees when the garage door 101 transitions between a closed position and an open position. The garage door 101 is a well-known and documented structure in our society. The garage door 101 comprises a plurality of door panels 111 and a plurality of hinges 112. The plurality of door panels 111 comprises a first door panel 131 and a second door panel 132.

Each of the plurality of door panels 111 is a disk-shaped structure. The face of each of the plurality of door panels 111 has a rectangular shape. The plurality of door panels 111 are assembled such that any second door panel 132 selected from the plurality of door panels 111 rotates relative to any first door panel 131 selected from the plurality of door panels 111 as the garage door 101 transitions between a closed position and an open position. The first door panel 131 is a disk-shaped rectangular block panel that forms a portion of the garage door 101. The second door panel 132 is a disk-shaped rectangular block panel that forms a portion of the garage door 101.

The plurality of hinges 112 interconnect the plurality of door panels 111 to form the plurality of door panels 111. Each of the plurality of door panels 111 attaches the first door panel 131 of the plurality of door panels 111 to the second door panel 132 of a plurality of door panels 111 such that the second door panel 132 rotates relative to the first door panel 131 as the garage door 101 transitions between a closed position and an open position. A subset of individual hinges 141 selected from the plurality of hinges 112 further attach a roller wheel selected from the plurality of roller wheels 103 to the plurality of door panels 111 of the garage door 101.

The plurality of hinges 112 comprises a collection of individual hinges 141. The individual hinge 141 is a hardware item used to attach any first door panel 131 selected from the plurality of door panels 111 to a second door panel 132 selected from the plurality of door panels 111. The individual hinge 141 is a rotating structure that allows the second door panel 132 to rotate relative to the first door panel 131 as the garage door 101 transitions between a closed position and an open position.

Each individual hinge 141 comprises a first hinge plate 151, a second hinge plate 152, a first plurality of knuckles 161, and a second plurality of knuckles 162. Each of the first plurality of knuckles 161 is a hollow cylindrical pipe that attaches to an edge of the first hinge plate 151. Each of the second plurality of knuckles 162 is a hollow cylindrical pipe that attaches to an edge of the second hinge plate 152. Each of the first plurality of knuckles 161 are identical. Each of the second plurality of knuckles 162 are identical. Any first knuckle selected from the first plurality of knuckles 161 is identical to any second knuckle selected from the second plurality of knuckles 162. The second plurality of knuckles 162 are offset from the first plurality of knuckles 161 such that the second plurality of knuckles 162 will interlace with the first plurality of knuckles 161 when the second hinge plate 152 is placed next to the first hinge plate 151.

The first hinge plate 151 is a metal plate that attaches to the first door panel 131 selected from the plurality of door panels 111. The first hinge plate 151 attaches the first plurality of knuckles 161 to the first door panel 131. The first plurality of knuckles 161 attach to the edge of the first hinge plate 151 that is proximal to the second door panel 132.

The second hinge plate 152 is a metal plate that attaches to the second door panel 132 selected from the plurality of door panels 111. The second hinge plate 152 attaches the second plurality of knuckles 162 to the second door panel 132. The second plurality of knuckles 162 attach to the edge of the second hinge plate 152 that is proximal to the first door panel 131.

The mounting position of the second hinge plate 152 on the second door panel 132 relative to the mounting position of the first hinge plate 151 on the first door panel 131 is such that the first plurality of knuckles 161 and the second plurality of knuckles 162 will interlace to form a single pipe-shaped structure when the first door panel 131 aligns with the second door panel 132.

When the individual hinge 141 is an individual hinge 141 selected from the subset of hinges selected from the plurality of hinges 112, the hinge pin joining the first plurality of knuckles 161 to the second plurality of knuckles 162 is the roller wheel axle 123 of the associated roller wheel selected from the plurality of roller wheels 103.

When the individual hinge 141 is not an individual hinge 141 selected from the subset of hinges selected from the plurality of hinges 112, the hinge pin joining the first plurality of knuckles 161 to the second plurality of knuckles 162 is a commercially available shaft.

The plurality of tracks 102 comprises a plurality of aligned tracks. Each of the plurality of tracks 102 receives one or more roller wheels selected from the plurality of roller wheels 103. Each of the plurality of tracks 102 guides the motion of the plurality of roller wheels 103.

Each of the plurality of compression springs 104 is a compression spring. Each of the plurality of compression springs 104 are identical. There is a one to one correspondence between the plurality of compression springs 104 and the plurality of roller wheels 103. Each plurality of compression springs 104 is a helical coil spring. Each individual compression spring 124 selected from the plurality of compression springs 104 installs in a roller wheel selected from the plurality of roller wheels 103. Each of the plurality of compression springs 104 mounts into the selected roller wheel such that the individual compression spring 124 deforms as the selected roller wheel installs in the track selected from the plurality of tracks 102. Each individual compression spring 124 applies a pressure to its selected roller wheel such that the individual compression spring 124 provides the force necessary to secure the selected roller wheel in the plurality of tracks 102.

Each of the plurality of roller wheels 103 is a rotating structure. Each of the plurality of roller wheels 103 are identical. Each of the plurality of roller wheels 103 installs in a track selected from the plurality of tracks 102 such that each of the plurality of roller wheels 103 rolls within the selected track. The plurality of roller wheels 103 attach the garage door 101 to the plurality of tracks 102. Each of the plurality of roller wheels 103 rolls within the selected track such that the garage door 101 will move along a path that aligns with the plurality of tracks 102 when the garage door 101 transitions between a closed position and an open position. Each roller wheel selected from the plurality of roller wheels 121 comprises an individual rotating wheel 121 comprises a rolling element bearing 122, a roller wheel axle 123, and an individual compression spring 124 selected from the plurality of compression springs 104.

The individual rotating wheel 121 is a disk-shaped structure with circular faces. The individual rotating wheel 121 installs in a track selected from the plurality of tracks 102. The individual rotating wheel 121 rotates within the track. The plurality of tracks 102 guides the motion of each individual rotating wheel 121 such that each individual rotating wheel 121 guides the path of motion of the garage door 101.

The rolling element bearing 122 is a commercially available bearing. The rolling element bearing 122 attaches the individual rotating wheel 121 to the roller wheel axle 123 such that the individual rotating wheel 121 rolls freely around the roller wheel axle 123 and within its selected track.

The roller wheel axle 123 is a cylindrical structure. The roller wheel axle 123 attaches the individual rotating wheel 121 and the rolling element bearing 122 to an individual hinge 141 selected from the subset of hinges selected from the plurality of hinges 112. The roller wheel axle 123 is geometrically similar to the hollow interiors of the first plurality of knuckles 161 and the second plurality of knuckles 162 of the individual hinge 141 selected from the subset of hinges selected from the plurality of hinges 112.

The outer diameter of the roller wheel axle 123 is lesser than the inner diameter of the first plurality of knuckles 161 and the second plurality of knuckles 162 of the selected hinge such that the roller wheel axle 123 will replace the hinge pin commonly used to assemble an individual hinge 141.

The roller wheel axle 123 forms the pivot that allows the first hinge plate 151 of the selected hinge to rotate relative to the second hinge plate 152 of the selected hinge. The roller wheel axle 123 inserts into the first hinge plate 151 and the second hinge plate 152 such that the center axes of the roller wheel axle 123, the first hinge plate 151, and the second hinge plate 152 align. The roller wheel axle 123 is a shaft that forms a pivot. The roller wheel axle 123 is sized such that the roller wheel axle 123 inserts through the interlaced first plurality of knuckles 161 the second plurality of knuckle 162. In this configuration, the roller wheel axle 123 forms a pivot that allows the second hinge plate 152 to rotate relative to the first hinge plate 151.

The individual compression spring 124 is a helical coil spring. The individual compression spring 124 forms a compression spring. The individual compression spring 124 is sized such that the roller wheel axle 123 inserts into the individual compression spring 124 such that the center axis of the roller wheel axle 123 and the individual compression spring 124 align.

The following definitions were used in this disclosure:

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Axle: As used in this disclosure, an axle is a cylindrical shaft that is inserted through the center of one or more wheels such that the axis of rotation of the one or more wheels and the center axis of the axle are aligned.

Bearing: As used in this disclosure, a bearing is a mechanical device that: 1) guides and limits the motion of a moving component relative to a fixed component; and, 2) reduces the friction between the moving component and the fixed component. The use of bearings is well known and documented in the mechanical arts.

Bias: As used in this disclosure, a bias is a consistent deviation or error relative to central or mean point that is designed into a system or device.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Closed Position: As used in this disclosure, a closed position refers to a movable barrier structure that is in an orientation that prevents passage through a port or an aperture. The closed position is often referred to as an object being “closed.” Always use orientation.

Compression Spring: As used in this disclosure, a compression spring is a spring that resists forces attempting to compress the spring in the direction of the center axis of the spring. The compression spring will return to its original position when the compressive force is removed.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Correspond: As used in this disclosure, the term correspond is used as a comparison between two or more objects wherein one or more properties shared by the two or more objects match, agree, or align within acceptable manufacturing tolerances.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Door: As used in this disclosure, a door is a movable or removable barrier that is attached to the wall of a room or the surface of a container for the purpose of allowing or preventing access through an aperture into the room or container.

Exterior: As used in this disclosure, the exterior is used as a relational term that implies that an object is not contained within the boundary of a structure or a space.

Form Factor: As used in this disclosure, the term form factor refers to the size and shape of an object.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1. Always use Correspond and One to One

Helical Spring: As used in this disclosure, a helical spring is a compression spring shaped in the form of a cylindrical helix.

Helix: As used in this disclosure, a helix is the three-dimensional structure that would be formed by a wire that is wound uniformly around the surface of a cylinder or a cone. If the wire is wrapped around a cylinder the helix is called a cylindrical helix. If the wire is wrapped around a cone, the helix is called a conical helix. A synonym for conical helix would be a volute.

Hinge: As used in this disclosure, a hinge is a device that permits the turning, rotating, or pivoting of a first object relative to a second object.

Interior: As used in this disclosure, the interior is used as a relational term that implies that an object is contained within the boundary of a structure or a space.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.

Open Position: As used in this disclosure, an open position refers to a movable barrier structure that is in an orientation that allows passage through a port or an aperture. The open position is often referred to as an object being “open.”

Orientation: As used in this disclosure, orientation refers to the positioning of a first object relative to: 1) a second object; or, 2) a fixed position, location, or direction.

Pivot: As used in this disclosure, a pivot is a rod or shaft around which an object rotates or swings.

Plate: As used in this disclosure, a plate is a smooth, flat and semi-rigid or rigid structure that has at least one dimension that: a) is of uniform thickness; and b) that appears thin relative to the other dimensions of the object. Plates are often disks. The face of the plate is a surface of the plate selected from the group consisting of: a) the surface of the plate with the greatest surface area; b) the surface of the plate that is distal from the surface of the plate with the greatest surface area. The edges of the plate comprises the surfaces of the plate that would not be considered faces as defined above. As defined in this disclosure, plates may be made of any material, but are commonly made of metal, plastic, and wood. When made of wood, a plate is often referred to as a board.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Roll: As used in this disclosure, the term roll refers to the motion of an object that is facilitated by the rotation of one or more wheels or casters.

Rolling Element Bearing: As used in this disclosure, a rolling element bearing comprises is a type of bearing comprising an inner race, an outer race, and a plurality of ball bearings. The plurality of ball bearings are sphere shaped. The inner race is a circular ring. The outer race is a circular ring with an inner diameter that is greater than the outer diameter of the inner race. The plurality of ball bearings are placed between the inner race and the outer race such that: 1) the inner race and the outer race are coaxially positioned; and, 2) the inner race rotates relative to the outer race. Typically, the inner race attaches to a first object and the outer race attaches to a second object such that the first object rotates relative to the second object. Typically, a rolling element bearing is disk-shaped. A rolling element bearing is said to be “locking” when the relative position of the inner race is locked into a fixed position relative to the outer race. Rolling element bearings, including locking versions, are: 1) commercially available; and, 2) well-known and documented in the mechanical arts.

Spring: As used in this disclosure, a spring is a device that is used to store mechanical energy. This mechanical energy will often be stored by: 1) deforming an elastomeric material that is used to make the device; 2) the application of a torque to a semi-rigid structure; or 3) a combination of the previous two items.

Track: As used in this disclosure, a track is a structural relationship between a first object and a second object that serves a purpose selected from the group consisting of: 1) fastening the second object to the first object; 2) controlling the path of motion of the first object relative to the second object in at least one dimension and in a maximum of two dimensions; or, 3) a combination of the first two elements of this group.

T Track Fastener: As used in this disclosure, a T track fastener is a fastening device that is used to attach a first object to a second object by sliding the first object on to the second object. The T track fastener further comprises a rail and a channel. The rail is attached to the first object and the channel is attached to the second object such that the first object is attached to the second object when the rail is inserted into the channel.

Wheel: As used in this disclosure, a wheel is a circular object that revolves around an axle or an axis and is fixed below an object to enable it to move easily over the ground. For the purpose of this disclosure, it is assumed that a wheel can only revolve in a forward and a backward direction. Wheels are often further defined with a rim and spokes. Spokes are also commonly referred to as a wheel disk.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A spring-biased door structure comprising
a garage door, a plurality of tracks, a plurality of roller wheels, and a plurality of compression springs;
wherein the plurality of roller wheels and the plurality of compression springs combine to attach the garage door to the plurality of tracks;
wherein the plurality of tracks guide the motion of the plurality of roller wheels;
wherein there is a one to one correspondence between the plurality of roller wheels and the plurality of compression springs;
wherein each individual compression spring generates a motive force that pushes its associated individual rotating wheel into a track selected from the plurality of tracks.

2. The spring-biased door structure according to claim 1 wherein the garage door is a multi-component rotating structure such that the garage door will bend when the garage door transitions between a closed position and an open position.

3. The spring-biased door structure according to claim 2
wherein the plurality of tracks comprises a plurality of aligned tracks;
wherein each of the plurality of tracks receives one or more roller wheels selected from the plurality of roller wheels;
wherein each of the plurality of tracks guides the motion of the plurality of roller wheels.

4. The spring-biased door structure according to claim 3
wherein each of the plurality of compression springs is a compression spring;
wherein each of the plurality of compression springs are identical;
wherein there is a one to one correspondence between the plurality of compression springs and the plurality of roller wheels;
wherein each individual compression spring selected from the plurality of compression springs installs in a roller wheel selected from the plurality of roller wheels;
wherein each of the plurality of compression springs mounts into the selected roller wheel such that the individual compression spring deforms as the selected roller wheel installs in the track selected from the plurality of tracks;
wherein each individual compression spring applies a pressure to its selected roller wheel such that the individual compression spring provides the force necessary to secure the selected roller wheel in the plurality of tracks.

5. The spring-biased door structure according to claim 4
wherein each of the plurality of roller wheels is a rotating structure;
wherein each of the plurality of roller wheels are identical;
wherein each of the plurality of roller wheels installs in a track selected from the plurality of tracks such that each of the plurality of roller wheels rolls within the selected track;
wherein each of the plurality of roller wheels rolls within the selected track such that the garage door will move along a path that aligns with the plurality of tracks when the garage door transitions between a closed position and an open position.

6. The spring-biased door structure according to claim 5
wherein the garage door comprises a plurality of door panels and a plurality of hinges;
wherein the plurality of hinges interconnect the plurality of door panels such that the relative position of any second door panel selected from the plurality of door panels will rotate relative to any first door panel selected from the plurality of door panels as the garage door transitions between the closed position and the open position.

7. The spring-biased door structure according to claim 6
wherein each of the plurality of door panels is a disk-shaped structure;
wherein the face of each of the plurality of door panels has a rectangular shape;
wherein the first door panel is a disk-shaped rectangular block panel that forms a portion of the garage door;
wherein the second door panel is a disk-shaped rectangular block panel that forms a portion of the garage door.

8. The spring-biased door structure according to claim 7
wherein the plurality of hinges comprises a collection of individual hinges;
wherein the individual hinge is a rotating structure that allows the second door panel to rotate relative to the first door panel as the garage door transitions between a closed position and an open position;
wherein a subset of individual hinges selected from the plurality of hinges further attach a roller wheel selected from the plurality of roller wheels to the plurality of door panels of the garage door.

9. The spring-biased door structure according to claim 8
wherein each individual hinge comprises a first hinge plate, a second hinge plate, a first plurality of knuckles, and a second plurality of knuckles;
wherein each of the first plurality of knuckles is a hollow cylindrical pipe that attaches to an edge of the first hinge plate;
wherein each of the second plurality of knuckles is a hollow cylindrical pipe that attaches to an edge of the second hinge plate.

10. The spring-biased door structure according to claim 9
wherein each of the first plurality of knuckles are identical;
wherein each of the second plurality of knuckles are identical;
wherein any first knuckle selected from the first plurality of knuckles is identical to any second knuckle selected from the second plurality of knuckles;
wherein the second plurality of knuckles are offset from the first plurality of knuckles such that the second plurality of knuckles will interlace with the first plurality of knuckles when the second hinge plate is placed next to the first hinge plate;
wherein the interlaced combination of the first plurality of knuckles and the second plurality are joined together with a hinge pin.

11. The spring-biased door structure according to claim 10 wherein the first hinge plate is a metal plate;
wherein the first hinge plate attaches to the first door panel selected from the plurality of door panels;
wherein the first hinge plate attaches the first plurality of knuckles to the first door panel;
wherein the first plurality of knuckles attach to the edge of the first hinge plate that is proximal to the second door panel;
wherein the second hinge plate is a metal plate;
wherein the second hinge plate attaches to the second door panel selected from the plurality of door panels;
wherein the second hinge plate attaches the second plurality of knuckles to the second door panel;
wherein the second plurality of knuckles attach to the edge of the second hinge plate that is proximal to the first door panel.

12. The spring-biased door structure according to claim 11 wherein the mounting position of the second hinge plate on the second door panel relative to the mounting position of the first hinge plate on the first door panel is such that the first plurality of knuckles and the second plurality of knuckles will interlace to form a single pipe-shaped structure when the first door panel aligns with the second door panel.

13. The spring-biased door structure according to claim 12 wherein each plurality of compression springs is a helical coil spring.

14. The spring-biased door structure according to claim 13
wherein each roller wheel selected from the plurality of roller wheels comprises a rotating wheel, a rolling element bearing, a roller wheel axle, and an individual compression spring selected from the plurality of compression springs;
wherein the rolling element bearing attaches the rotating wheel to the roller wheel axle;
wherein the roller wheel axle inserts through the compression spring;
wherein the roller wheel axle inserts into the first plurality of knuckles of an individual hinge selected from the subset of hinges selected from the plurality of hinges;
wherein the roller wheel axle inserts into the second plurality of knuckles of an individual hinge selected from the subset of hinges selected from the plurality of hinges.

15. The spring-biased door structure according to claim 14
wherein the individual rotating wheel is a disk-shaped structure with circular faces;
wherein the individual rotating wheel installs in a track selected from the plurality of tracks;
wherein the individual rotating wheel rotates within the track;
wherein the plurality of tracks guides the motion of each individual rotating wheel such that each individual rotating wheel guides the path of motion of the garage door.

16. The spring-biased door structure according to claim 15
wherein the rolling element bearing is a commercially available bearing;
wherein the rolling element bearing attaches the individual rotating wheel to the roller wheel axle such that the individual rotating wheel rolls freely around the roller wheel axle and within its selected track.

17. The spring-biased door structure according to claim 16
wherein the roller wheel axle is a cylindrical structure;
wherein the roller wheel axle attaches the individual rotating wheel and the rolling element bearing to an individual hinge selected from the subset of hinges selected from the plurality of hinges;
wherein the roller wheel axle is geometrically similar to the hollow interiors of the first plurality of knuckles and the second plurality of knuckles of the individual hinge selected from the subset of hinges selected from the plurality of hinges;
wherein the outer diameter of the roller wheel axle is lesser than the inner diameter of the first plurality of knuckles and the second plurality of knuckles of the selected hinge.

18. The spring-biased door structure according to claim 17
wherein when the individual hinge is an individual hinge selected from the subset of hinges selected from the plurality of hinges, the hinge pin joining the first plurality of knuckles to the second plurality of knuckles is the roller wheel axle of the associated roller wheel selected from the plurality of roller wheels;
wherein when the individual hinge is not an individual hinge selected from the subset of hinges selected from the plurality of hinges, the hinge pin joining the first plurality of knuckles to the second plurality of knuckles is a commercially available shaft.

19. The spring-biased door structure according to claim 18
wherein the roller wheel axle forms the pivot that allows the first hinge plate of the selected hinge to rotate relative to the second hinge plate of the selected hinge;
wherein the roller wheel axle inserts into the first hinge plate and the second hinge plate such that the center axes of the roller wheel axle, the first hinge plate, and the second hinge plate align.
